(19) United States
(12) Patent Application Publication
(10) Pub. No.: US 2018/0289582 A1
(43) Pub. Date: Oct. 11, 2018

(54) MASSAGE APPARATUS FOR LEGS AND FEET AND MASSAGE CHAIR HAVING THE MASSAGE APPARATUS

(71) Applicants: KEVIN LE, RICHLAND HILLS, TX (US); THANH LE, GRAND PRAIRIE, TX (US); VARAD NITIN GOKHALE, IRVING, TX (US)

(72) Inventors: KEVIN LE, RICHLAND HILLS, TX (US); THANH LE, GRAND PRAIRIE, TX (US); VARAD NITIN GOKHALE, IRVING, TX (US)

(73) Assignee: LURACO TECHNOLOGIES, INC., ARLINGTON, TX (US)

(21) Appl. No.: 15/415,822

(22) Filed: Jan. 25, 2017

(51) Int. Cl. A61H 15/00

(52) U.S. Cl. CPC A61H 15/0078; A61H 2205/106; A61H 2201/0149; A61H 2201/5058; A61H 2015/0021; A61H 2205/12

(57) ABSTRACT

A legs and feet massage apparatus for providing massaging effects to the legs and feet of a user is disclosed. The legs and feet massage apparatus includes a frame, a feet massage roller assembly, and limit means. The frame includes opposing guide rails and at least one connecting bar. Each guide rail includes an upper end, a lower end, a vertical section, a horizontal section, a connecting section, an outer side, an inner side, and a guide channel. The roller assembly includes feet massage roller devices and a motor. The roller devices are moved along the guide channels by the motor providing power to rotate the roller devices whereby the roller devices move along the guide channels while also providing massaging effects to soles of the feet and backsides of the ankles and calves of the user. A massage chair having a legs and feet massage apparatus is also disclosed.

### BACKGROUND OF THE INVENTION

### Field of the Invention

The present invention generally relates to massage chairs and massage devices and apparatuses for massage chairs. More specifically, as one aspect of the present invention, the invention is directed to a legs and feet massage apparatus for providing massaging benefits or effects to the legs and feet of a user. As another aspect of the present invention, the invention is directed to a chair, preferably a massage chair, having a legs and feet massage apparatus.

### Description of the Related Art

Massage chairs and massage devices and apparatuses for massage chairs are known in the art.

There are a number of patents, published patent applications, and/or non-patent publications directed at massage chairs and massage devices and apparatuses for massage chairs that show, describe and/or teach massage benefits or effects being provided to an upper body area, such as a back body area, of a user. Further, there are a number of patents, published patent applications, and/or non-patent publications directed at massage chairs and massage devices and apparatuses for massage chairs that show, describe and/or teach massage benefits or effects being provided to the legs and feet of a user.

The present invention overcomes one or more of the shortcomings of massage chairs and massage devices and apparatuses for massage chairs. The Applicant is unaware of inventions or patents, taken either singly or in combination, which are seen to describe the present invention as claimed.

### SUMMARY OF THE INVENTION

As one aspect of the present invention, the invention is directed to a legs and feet massage apparatus for providing massaging benefits or effects to the legs and feet of a user.

As a non-limiting example, the legs and feet massage apparatus comprises: a frame; a feet massage roller assembly; two sets of calf massage devices; and a pair of limit sensors.

The frame includes a pair of opposing guide rails, an upper connecting bar, and a lower connecting bar.

Each guide rail includes an upper or first end, a lower or second end, an upper or vertical section located adjacent the upper end, a lower or horizontal section located about the lower end, a bend section connecting the vertical section and horizontal section of the corresponding guide rail, an outer side, an inner side, and a guide channel extending from the vertical section into the horizontal section and running along the inner side of the guide rail. The guide channel includes a plurality of gear teeth for engaging with a plurality of driving gears of a plurality of feet massage roller devices when the plurality of feet massage roller devices move upward and downward in a generally vertical direction along the vertical section and bend section from the upper ends toward the lower ends of the guide rails and vice versa, respectively, and moves forward and rearward in a generally horizontal direction along the horizontal section.

Each of the upper connecting bar and lower connecting bar has a first end, a second end, and a body portion extending from the first end to the second end, respectively. The upper connecting bar is secured, attached or connected to the upper ends of the guide rails, while the lower connecting bar is secured, attached or connected to the lower ends of the guide rails. The upper connecting bar and lower connecting bar help to stabilize the frame and the positioning of the guide rails relative to one another.

The feet massage roller assembly includes: a plurality of feet massage roller devices; a worm gear device; and a motor. The plurality of feet massage roller devices may be moved along the guide channels of the pair of guide rails by the motor powering the worm gear device to rotate the plurality of feet massage roller devices such that the plurality of feet massage roller devices move along the guide channels while also providing massaging benefits or effects to the bottoms or soles of the feet and backsides of the ankles and calves of the user.

Each feet massage roller device has a first end with a rotational shaft that is connected to the worm gear device, a second end that has a plurality of driving gears for engaging with the corresponding guide channel of the guide rails, and a main massage roller positioned between the first end and second end of the feet massage roller device. Each main massage roller has a plurality of smaller massage rollers surrounding the outer surface of the main massage roller. Thus, preferably, the plurality of smaller massage rollers make contact with and provide massaging benefits or effects to the bottom or sole of the feet and backside of the ankle and calves of the user as the plurality of feet massage roller devices move along the guide channels of the guide rails.

The worm gear device is in communication with or connected to the motor such that the worm gear device is powered by the motor to rotate the plurality of feet massage roller devices via the rotational shafts so that the plurality of feet massage roller devices can move along the guide channel.

The motor powers the worm gear device to rotate the plurality of feet massage roller devices via the rotational shafts so that the plurality of feet massage roller devices can move along the guide channels of the guide rails.

Each of the two sets of calf massage devices includes: a first or upper calf massage device; and a second or lower calf massage device. Both of the upper calf massage device and lower calf massage device of each set are secured or attached along the vertical section of the corresponding guide rail such that, preferably, the upper calf massage devices face toward one another and the lower calf massage devices face toward one another.

Preferably, each of the upper calf massage devices and lower calf massage devices has an attachment plate, a wiring coil secured or attached to the inner side of the attachment plate, and a metal core or plunger secured or attached to the inner side of the wiring coil. Preferably, the wiring coil is an energized solenoid coil that produces linear movement of the corresponding metal core or plunger so that punching massaging effects is provided to the calves of the user. Thus, preferably, the plurality of metal cores or plungers make contact with and provide punching massaging benefits or effects to the sides of the calves of the user when the two sets of calf massage devices are in use.

Limit sensors control the traveling distance of the plurality of feet massage roller devices along the guide channels of the guide rails in either direction, and prevent the plurality of feet massage roller devices from exiting the guide channels at either end of the guide rails.

As another aspect of the present invention, the invention is directed to a chair, preferably a massage chair, having a legs and feet massage apparatus as described above.

### BRIEF DESCRIPTION OF THE DRAWINGS

FIG. 1 is a front, right side, perspective view of a legs and feet massage apparatus according to the present invention;

FIG. 2 is a front, left side, perspective view of the legs and feet massage apparatus of FIG. 1;

FIG. 3 is a front view of the legs and feet massage apparatus of FIG. 1;

FIG. 4 is a rear view of the legs and feet massage apparatus of FIG. 1;

FIG. 5 is a right side view of the legs and feet massage apparatus of FIG. 1;

FIG. 6 is a left side view of the legs and feet massage apparatus of FIG. 1;

FIG. 7 is a top view of the legs and feet massage apparatus of FIG. 1;

FIG. 8 is a bottom view of the legs and feet massage apparatus of FIG. 1;

FIG. 9 is a front, perspective view of a chair having a legs and feet massage apparatus according to the present invention, wherein the legs and feet massage apparatus is positioned inside a chair covering material;

FIG. 10 is a perspective view of a body massage apparatus for a massage chair according to the present invention;

FIG. 11 is a front view of the body massage apparatus for a massage chair of FIG. 10;

FIG. 12 is a right side view of the body massage apparatus for a massage chair of FIG. 10;

FIG. 13 is a perspective, front view of a massage device of the body massage apparatus for a massage chair of FIG. 10;

FIG. 14 is a perspective, front and right side view of a massage device of the body massage apparatus for a massage chair of FIG. 10;

FIG. 15 is a perspective, rear view of a massage device of the body massage apparatus for a massage chair of FIG. 10;

FIG. 16 is a perspective, rear and right side view of a massage device of the body massage apparatus for a massage chair of FIG. 10;

FIG. 17 is another perspective, rear and right side view of a massage device of the body massage apparatus for a massage chair of FIG. 10;

FIG. 18 is an environmental perspective, front and right side view of a massage chair according to the present invention, showing at least one health monitoring device or system being positioned on or secured to a user;

FIG. 19 is a perspective, left side view of a chair having a legs and feet massage apparatus secured to a body massage apparatus according to the present invention, wherein a chair covering material is partially revealed to show a substantial portion of the body massage apparatus, and wherein the chair covering material is partially removed to show a portion of the legs and feet massage apparatus; and

FIG. 20 is a close-up perspective view of the legs and feet massage apparatus secured to the body massage apparatus of FIG. 19.

It should be understood that the above-attached figures are not intended to limit the scope of the present invention in any way.

### DETAILED DESCRIPTION OF THE PRESENT INVENTION

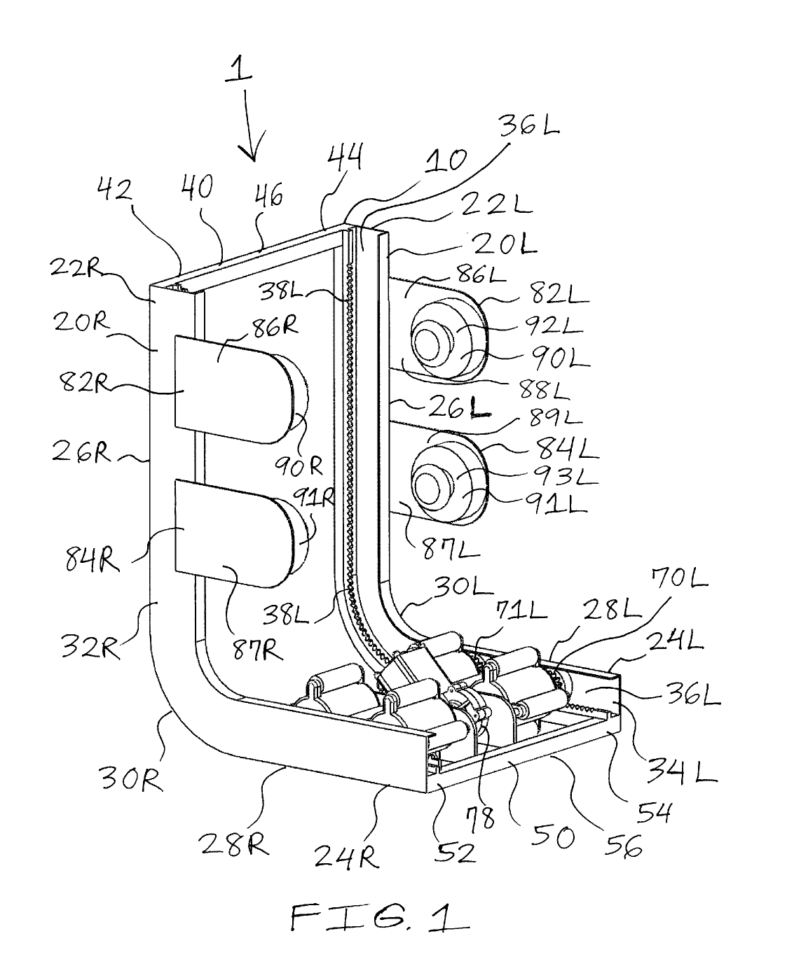

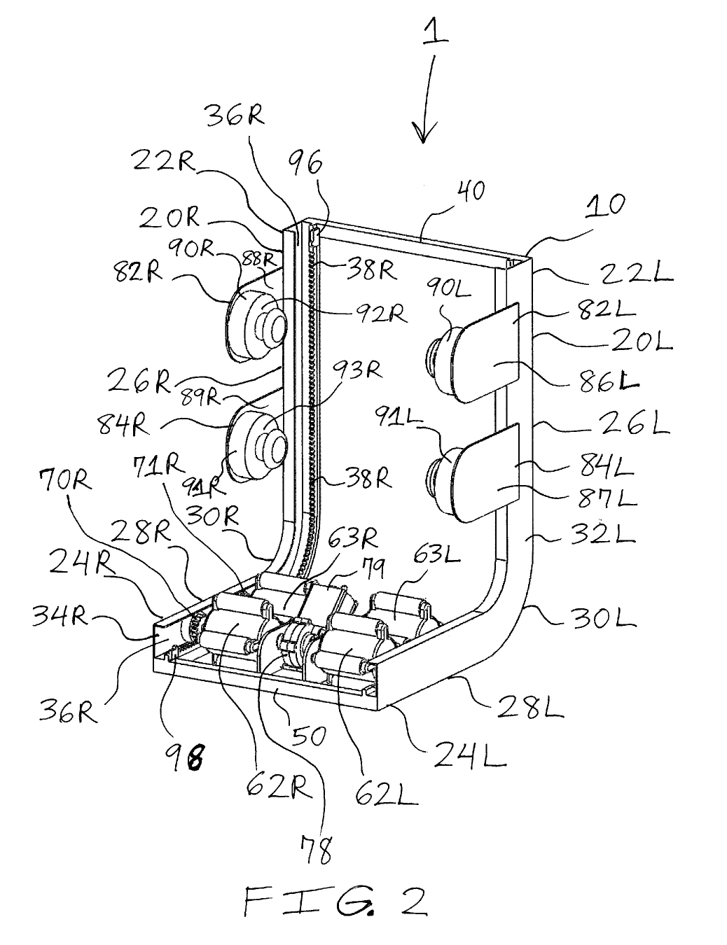

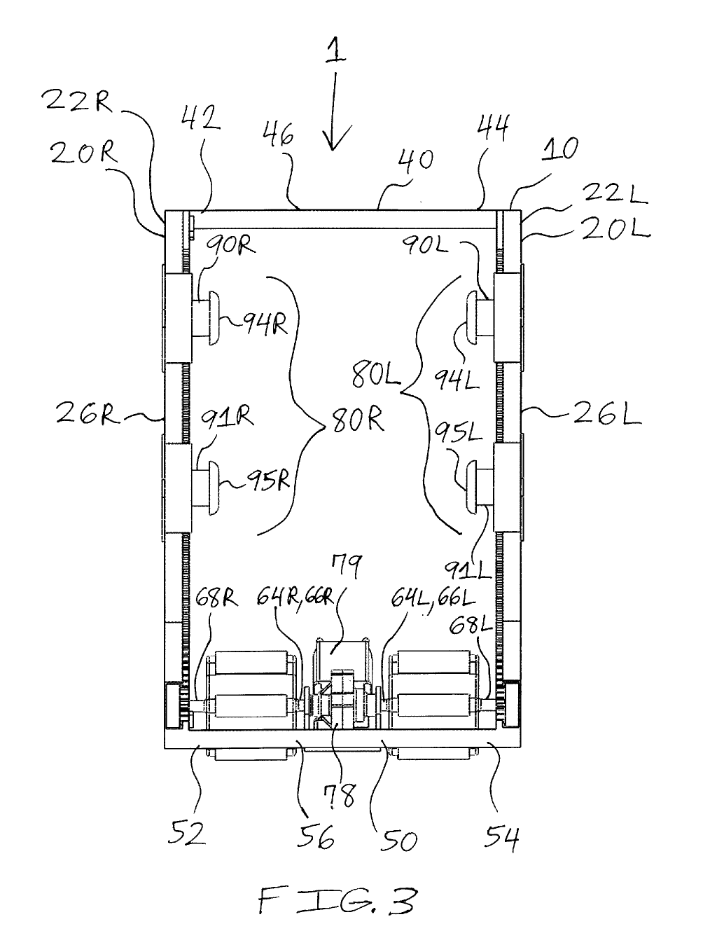

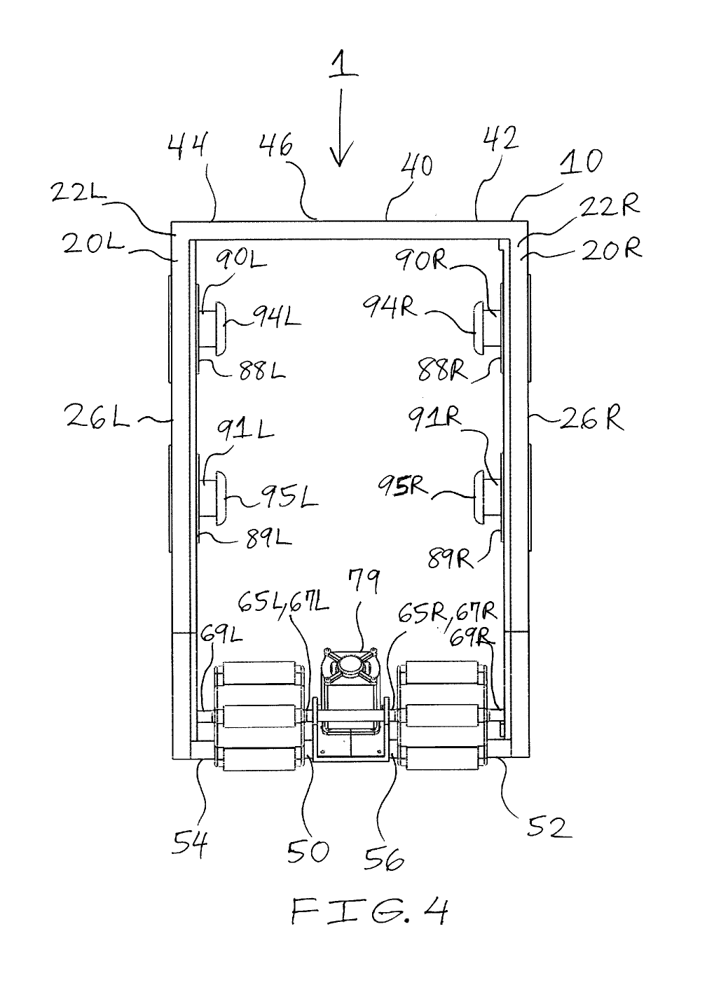

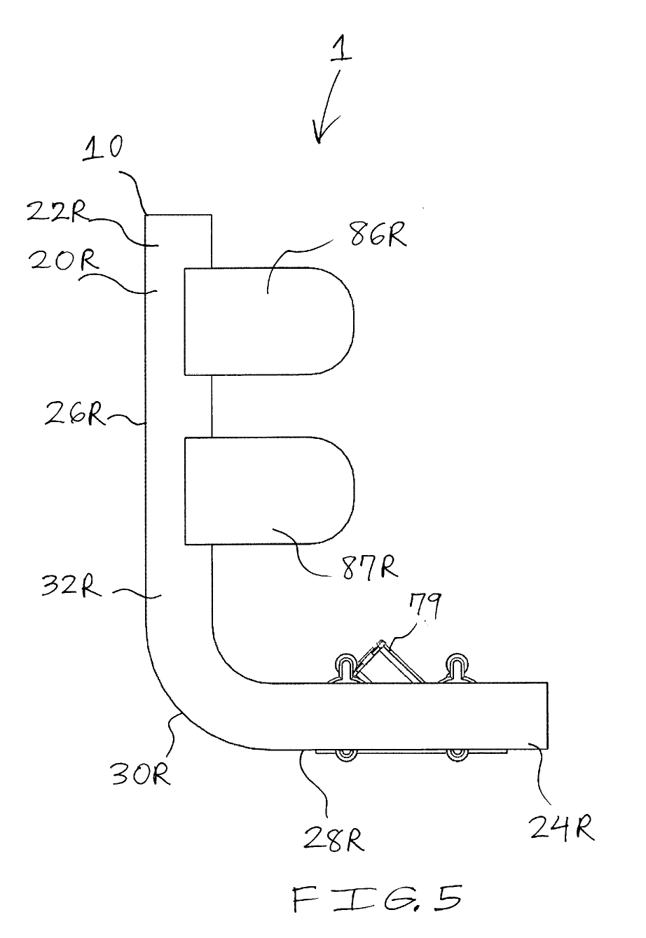

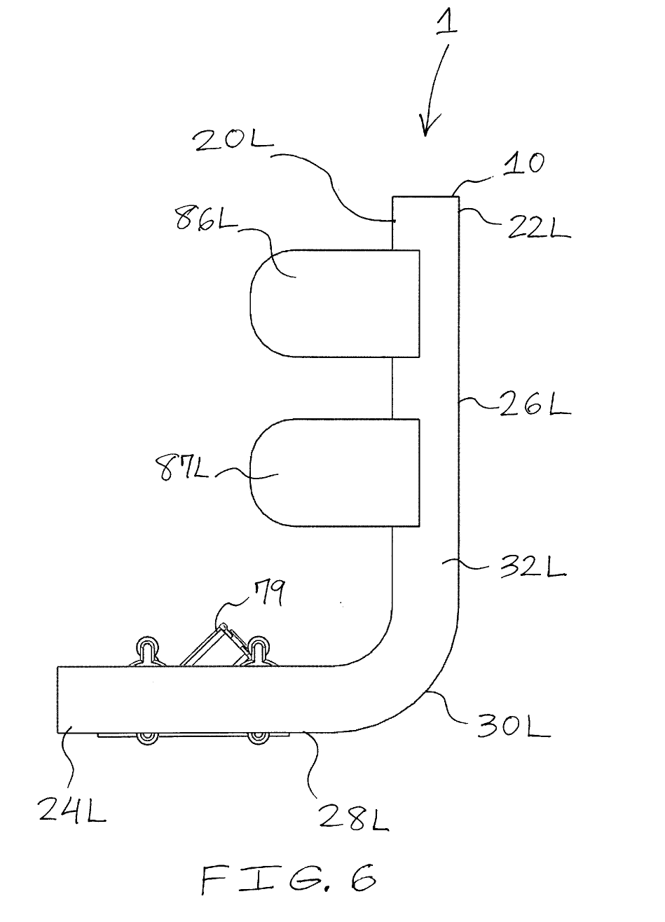

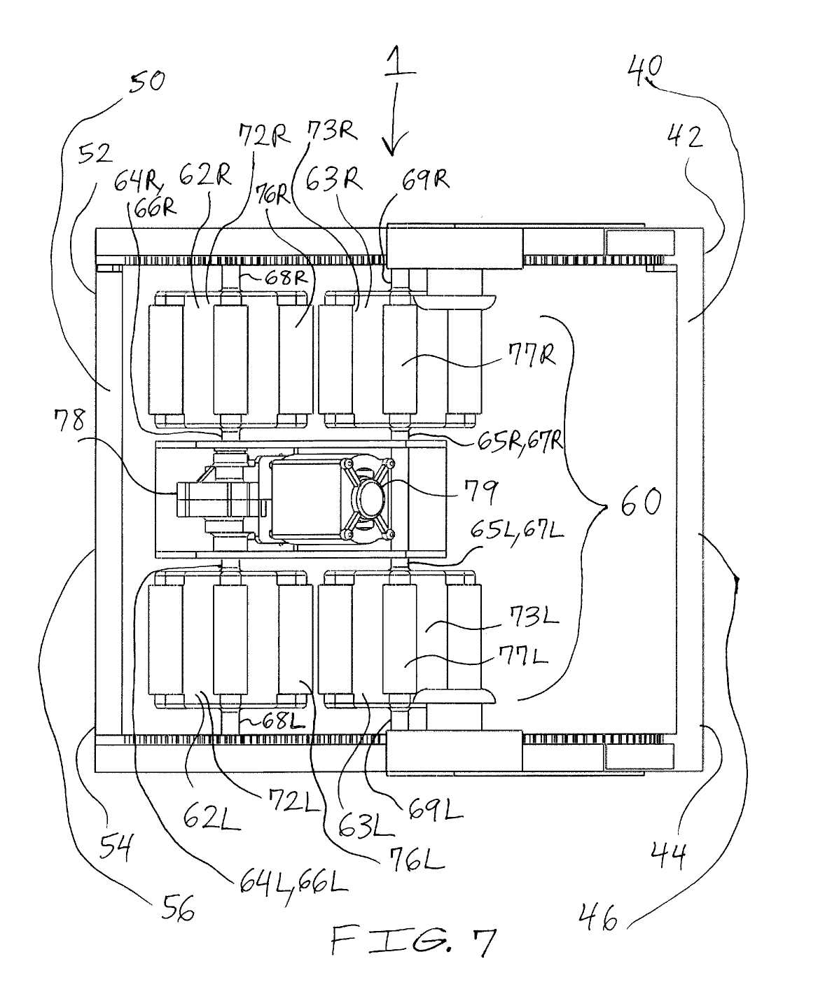

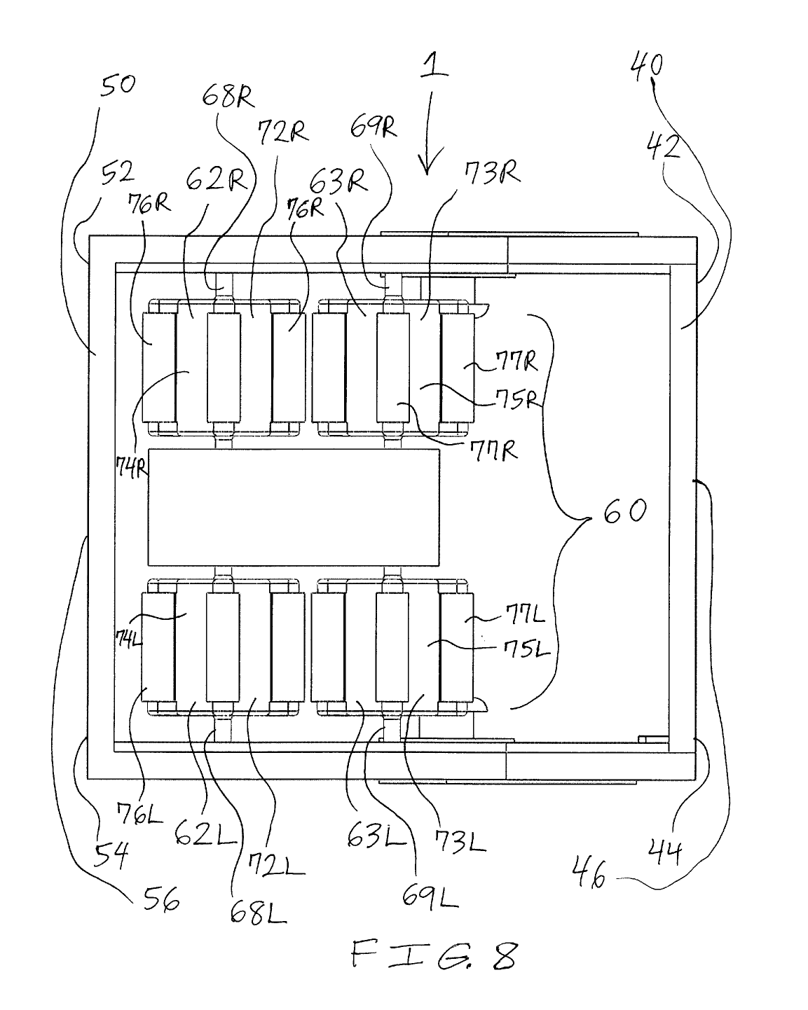

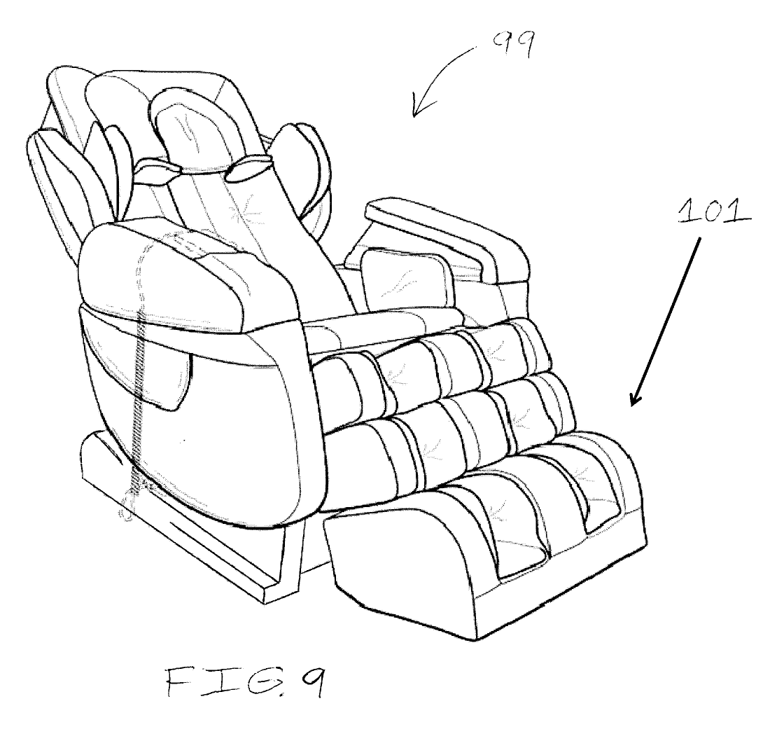

Referring to FIGS. 1-8 and as one aspect of the present invention, the invention is directed to a legs and feet massage apparatus 1 for providing massaging benefits or effects to the legs and feet of a user (not shown) wherein the legs and feet massage apparatus 1 may be secured, attached or affixed to a chair, preferably a massage chair, as shown in FIGS. 9 and 18-20.

As a non-limiting example, the legs and feet massage apparatus 1 comprises: a frame 10; a feet massage roller assembly 60 (preferably motorized); two sets of calf massage devices 80R,80L; and a pair of limit sensors 96,98.

The frame 10 includes a pair of opposing guide rails 20R,20L, an upper connecting bar 40, and a lower connecting bar 50.

Preferably, the guide rails 20R,20L are substantially similar or mirror images of one another. Each guide rail 20R,20L includes an upper or first end 22R,22L, a lower or second end 24R,24L, an upper or vertical section 26R,26L located adjacent the upper end 22R,22L, a lower or horizontal section 28R,28L located about the lower end 24R,24L, a bend section 30R,30L connecting the vertical section 26R,26L and horizontal section 28R,28L of the corresponding guide rail 20R,20L, an outer side 32R,32L, an inner side 34R,34L, and a guide channel 36R,36L extending from the vertical section 26R,26L into the horizontal section 28R,28L and running along the inner side 34R,34L of the guide rail 20R,20L. The guide channel 36R,36L includes a plurality of gear teeth 38R,38L for engaging with a plurality of driving gears 70R,70L,71R,71L of a plurality of feet massage roller devices 62R,62L,63R,63L of the feet massage roller assembly 60 when the plurality of feet massage roller devices 62R,62L,63R,63L move upward and downward in a generally vertical direction along the vertical section 26R,26L and bend section 30R,30L from the upper ends 22R,22L toward the lower ends 24R,24L of the guide rails 20R,20L and vice versa, respectively, and moves forward and rearward in a generally horizontal direction along the horizontal section 28R,28L. Preferably, each of the guide rails 20R,20L has a generally “L-shaped” configuration. In this configuration, the lower portion of the “L” includes the horizontal section 28R,28L and a portion of the bend section 30R,30L, and the upper portion of the “L” includes the vertical section 26R,26L and also a portion of the bend section 30R,30L.

Each of the upper connecting bar 40 and lower connecting bar 50 has a first end 42,52, a second end 44,54, and a body portion 46,56 extending from the first end 42,52 to the second end 44,54, respectively. The upper connecting bar 40 is secured, attached or connected to the upper ends 22R,22L of the guide rails 20R,20L, while the lower connecting bar 50 is secured, attached or connected to the lower ends 24R,24L of the guide rails 20R,20L. The upper connecting bar 40 and lower connecting bar 50 help to stabilize the frame 10 and the positioning of the guide rails 20R,20L relative to one another.

The feet massage roller assembly 60 includes: the plurality of feet massage roller devices 62R,62L,63R,63L (a total of four in this embodiment); a worm gear device 78; and a motor 79. The plurality of feet massage roller devices 62R,62L,63R,63L may be moved along the guide channels 36R,36L of the pair of guide rails 20R,20L by the motor 79 powering the worm gear device 78 to rotate the plurality of feet massage roller devices 62R,62L,63R,63L such that the plurality of feet massage roller devices 62R,62L,63R,63L move along the guide channels 36R,36L while also providing massaging benefits or effects to the bottoms or soles of the feet and backsides of the ankles and calves of the user.

Each feet massage roller device 62R,62L,63R,63L has a first end 64R,64L,65R,65L with a rotational shaft 66R,66L,67R,67L that is connected to the worm gear device 78 or motor 79, respectively, a second end 68R,68L,69R,69L that has a plurality of driving gears 70R,70L,71R,71L for engaging with the corresponding guide channel 36R,36L of the guide rails 20R,20L, and a main massage roller 72R,72L,73R,73L positioned between the first end 64R,64L,65R,65L and second end 68R,68L,69R,69L. Each main massage roller 72R,72L,73R,73L has a plurality of smaller massage rollers 76R,76L,77R,77L surrounding the outer surface 74R,74L,75R,75L of the main massage roller 72R,72L,73R,73L. Thus, preferably, the plurality of smaller massage rollers 76R,76L,77R,77L make contact with and provide massaging benefits or effects to the bottom or sole of the feet and backside of the ankle and calves of the user as the plurality of feet massage roller devices 62R,62L,63R,63L move along the guide channels 36R,36L of the guide rails 20R,20L.

The worm gear device 78 is in communication with or connected to the motor 79 such that the worm gear device 78 is powered by the motor 79 to rotate the plurality of feet massage roller devices 62R,62L via the rotational shafts 66R,66L so that the plurality of feet massage roller devices 62R,62L,63R,63L can move along the guide channel 36R,36L. The worm gear device 78 may be any applicable worm gear device known to one of ordinary skill in the art.

The motor 79 powers the worm gear device 78 to rotate the plurality of feet massage roller devices 62R,62L via the rotational shafts 66R,66L while itself rotating the plurality of feet massage roller devices 63R,63L via the rotational shafts 67R,67L such that the plurality of feet massage roller devices 62R,62L,63R,63L can move along the guide channels 36R,36L of the guide rails 20R,20L. The motor 79 may be any applicable motor known to one of ordinary skill in the art.

Each of the two sets of calf massage devices 80R,80L includes: a first or upper calf massage device 82R,82L; and a second or lower calf massage device 84R,84L. Both of the upper calf massage device 82R,82L and lower calf massage device 84R,84L of each set 80R,80L are secured or attached along the vertical section 26R,26L of the corresponding guide rail 20R,20L such that, preferably, the upper calf massage devices 82R,82L face toward one another and the lower calf massage devices 84R,84L face toward one another.

Preferably, each of the upper calf massage devices 82R,82L and lower calf massage devices 84R,84L has an attachment plate 86R,86L,87R,87L, a wiring coil 90R,90L,91R,91L secured or attached to the inner side 88R,88L,89R,89L of the attachment plate 86R,86L,87R,87L, and a metal core or plunger 94R,94L,95R,95L secured or attached to the inner side 92R,92L,93R,93L of the wiring coil 90R,90L,91R,91L. Preferably, the wiring coil 90R,90L,91R,91L is an energized solenoid coil that produces linear movement of the corresponding metal core or plunger 94R,94L,95R,95L so that punching massaging effects is provided to the calves of the user. Thus, preferably, the plurality of metal cores or plungers 94R,94L,95R,95L make contact with and provide punching massaging benefits or effects to the sides of the calves of the user when the two sets of calf massage devices 80R,80L are in use.

Limit sensors 96,98 control the traveling distance of the plurality of feet massage roller devices 62R,62L,63R,63L along the guide channels 36R,36L of the guide rails 20R,20L in either direction, and prevent the plurality of feet massage roller devices 62R,62L,63R,63L from exiting the guide channels 36R,36L at either end of the guide rails 20R,20L. As a non-limiting example, a first limit sensor 96 may be positioned at the upper end 22R,22L of a guide rail 20R,20L, and a second limit sensor 98 may be positioned at the lower end 24R,24L of the same guide rail 20R,20L.

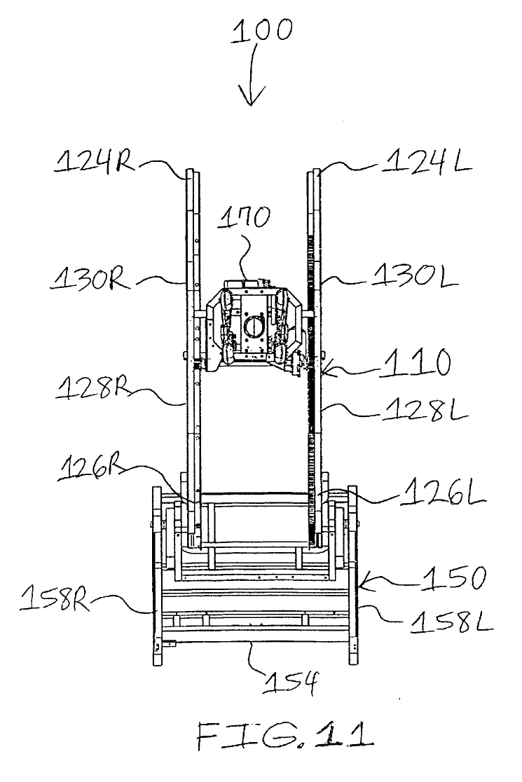

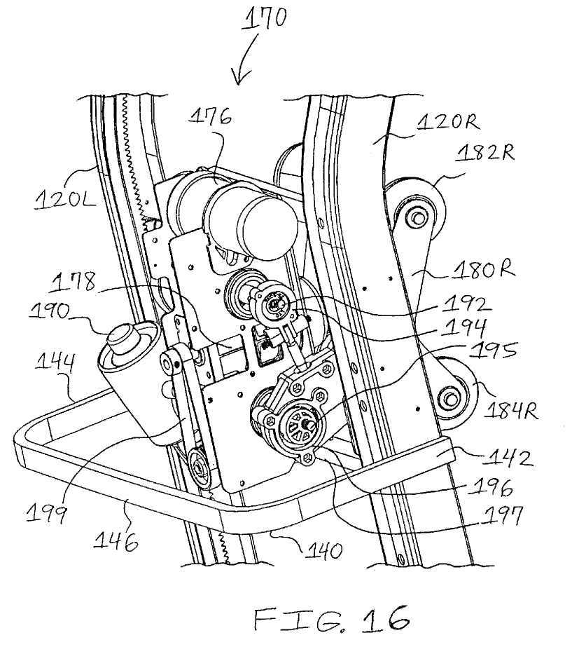

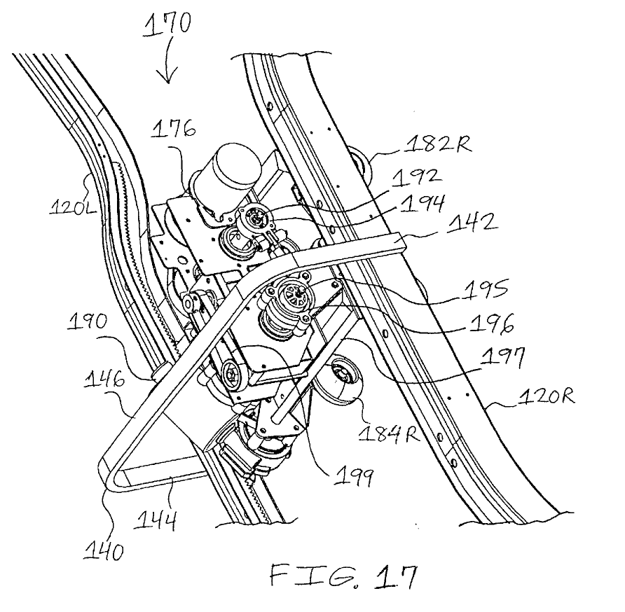

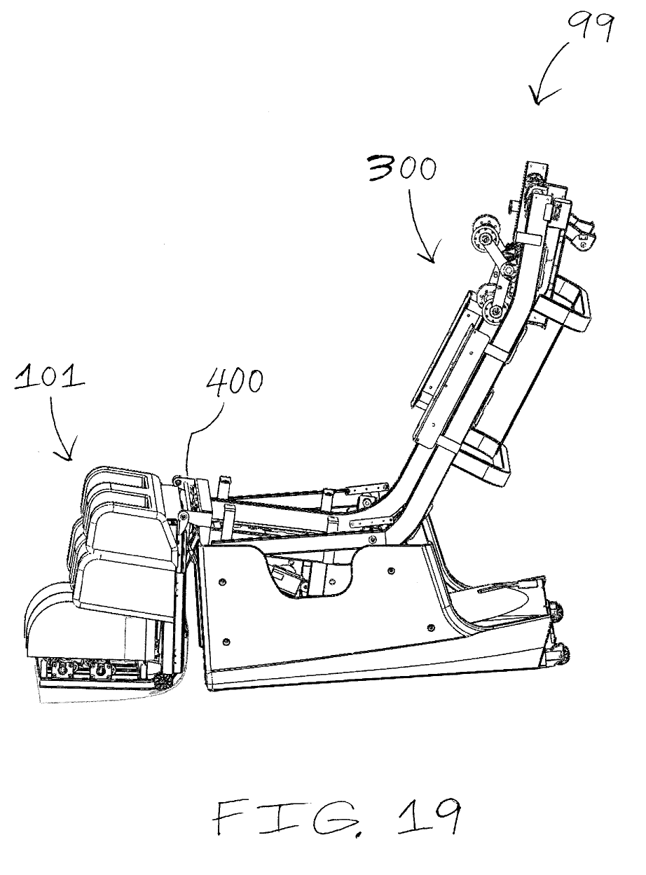

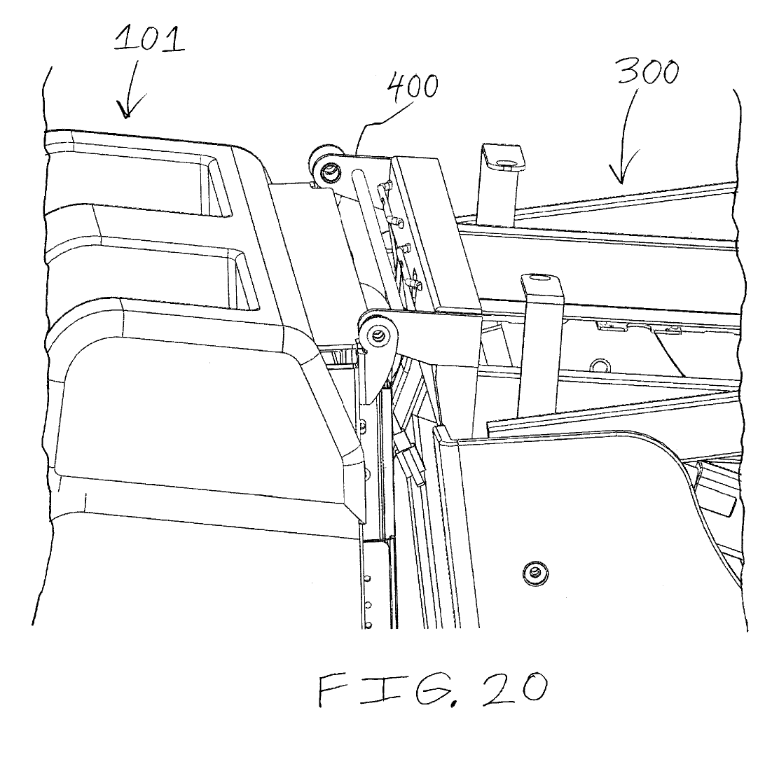

Referring to FIGS. 9-20 and as another aspect of the present invention, the invention is directed to a chair 99, preferably a massage chair, having a legs and feet massage apparatus 101. Preferably, the legs and feet massage apparatus 101 is substantially or exactly the same as the legs and feet massage apparatus 1 described above and shown in FIGS. 1-8. As stated above and shown in FIG. 9, the legs and feet massage apparatus 101 is secured, attached or affixed to a chair 99, preferably a massage chair, and positioned inside a chair covering material, such as, but not limited to, leather, suede, a man-made material, and any other covering material known to one of ordinary skill in the art. As shown in FIG. 19, the chair covering material is partially revealed to show the legs and feet massage apparatus 101 being positioned inside the chair covering material, and the chair covering material is also partially revealed to show a substantial portion of a body massage apparatus 300. FIG. 20 shows a non-limiting example of a securing device 400 that secures the legs and feet massage apparatus 101 to the body massage apparatus 300. Preferably, body massage apparatus 300 is substantially similar to body massage apparatus 100.

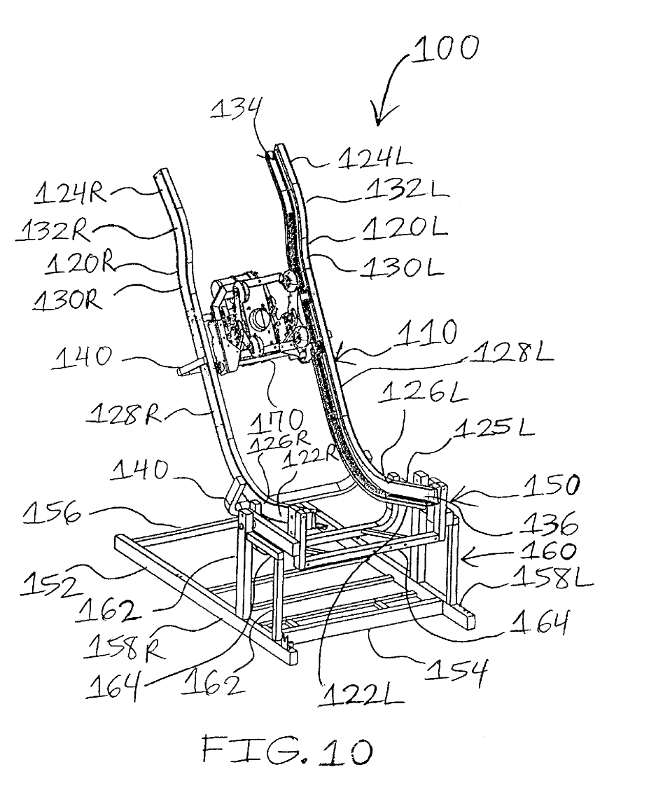

Referring to FIGS. 10-18 and in one embodiment, the massage chair 99 comprises a body massage apparatus 100 wherein massage benefits or effects are provided to a back body area, a bottom body area, and a thigh body area of a user (not shown). Massage benefits or effects may also be provided to a head and neck body area of the user. The body massage apparatus 100 includes a frame 110 and a body massage device 170. Also, in another embodiment, the massage chair 200 includes a body massage apparatus and at least one health monitoring device 210. The body massage apparatus of massage chair 200 is preferably body massage apparatus 100.

As a non-limiting example and best shown in FIGS. 10-12, the frame 110 of the body massage apparatus 100 includes a pair of opposing guide rails 120R,120L, a plurality of guide rails stabilizing bars 140, and a base stand 150. The guide rails 120R,120L are secured to the base stand 150, and are positioned generally above the base stand 150. The base stand 150 supports the weights of the guide rails 120R,120L, body massage device 170, and user (not shown) of the massage chair.

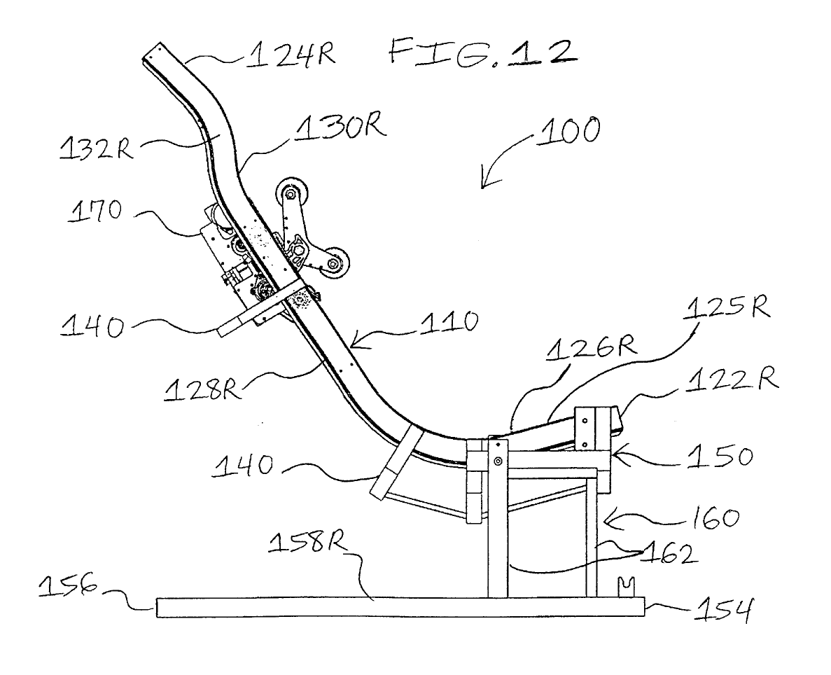

Preferably, the guide rails 120R,120L are substantially similar or mirror images of one another. Each of the guide rails 120R,120L includes a first end 122R,122L, a second end 124R,124L, a thigh body area portion 125R,125L located adjacent the first end 122R,122L, a seat or bottom body area portion 126R,126L located adjacent the thigh body area portion 125R,125L and away from the first end 122R,122L, a back body area portion 128R,128L extending upward from the bottom body area portion 126R,126L, a head and neck body area portion 130R,130L extending upward from the back body area portion 128R,128L and located about the second end 124R,124L, an outer side 132R,132L, an inner side 134, and a guide channel 136 extending from the thigh body area portion 125R,125L to the back body area portion 128R,128L, preferably to the head and neck body area portion 130R,130L, and running along the inner side 134 of the guide rail 120R,120L. The guide channel 136 includes gear teeth 138 for engaging with at least one gear member from the body massage device 170 when the body massage device 170 moves upward and downward in a generally vertical direction from the first end 122R,122L toward the second end 124R,124L of the guide rail 120R,120L and vice versa, respectively. Preferably, each of the guide rails 120R,120L has a generally “L-shaped” configuration. In this configuration, the lower portion of the “L” includes the thigh body area portion 125R,125L and bottom body area portion 126R,126L, and the upper portion of the “L” includes the back body area portion 128R,128L and head and neck body area portion 130R,130L. As best shown in FIGS. 10 and 12, more preferably, each of the guide rails 120R,120L has a reclining “L-shaped” configuration.

The plurality of guide rails stabilizing bars 140 help to stabilize the positioning of the guide rails 120R,120L relative to one another. Each of the guide rails stabilizing bars 140 has a first end 142, a second end 144, and a body portion 146 extending from the first end 142 to the second end 144. Preferably, each of the guide rails stabilizing bars 140 has a generally “U-shaped” configuration. The guide rails stabilizing bars 140 are secured at predetermined locations along the outer sides 132R,132L of the guide rails 120R,120L.

The base stand 150 includes a base 152 and a guide rails support structure 160. The base 152 includes a first or front end 154, a second or rear end 156, and a pair of opposing sides 158R,158L. The guide rails support structure 160 is secured about the front end 154 of the base 152, and is positioned above the base 152. The guide rails support structure 160 includes a plurality of vertical bars or members 162 and a plurality of horizontal bars or members 164. The plurality of vertical bars 162 extend upward from the pair of opposing sides 158R,158L of the base 152, and, along with the plurality of horizontal bars 164, form a support frame with a “square-shaped” or “rectangular-shaped” box configuration.

Since the base stand 150 supports the weights of the guide rails 120R,120L, body massage device 170, and user of the massage chair, the base stand 150 is preferably made or manufactured of a strong material, such as, but not limited to, steel, metal, wood, hard plastic, any combination of the listed materials, and any material or combination of materials known to one of ordinary skill in the art. Also, the guide rails 120R,120L may be made or manufactured of steel, metal, wood, plastic, any combination of the listed materials, and any material or combination of materials known to one of ordinary skill in the art.

The body massage device 170 includes a power source, at least one massage element, and at least one gear member. The body massage device 170 may be a conventional massage device or any applicable massage device that is known to one of ordinary skill in the art.

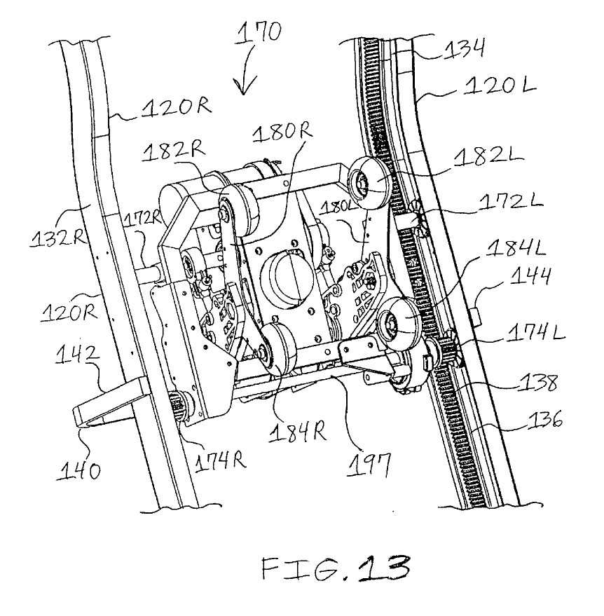

As a non-limiting example and as best shown in FIGS. 13-17, the body massage device 170 includes a pair of massage device moving members 172R,172L, a pair of gear members 174R,174L, a pair of massage arms 180R,180L, a first motor 176, a second motor 178, a third motor 190, a rotational shaft 192 driven by the first motor 176, a pair of rotation to knocking translator members 194, a rotational shaft 195 driven by the second motor 178, a pair of rotation to kneading translator members 196, a rotational shaft 197 for vertical movement gears driving, a speed reduction belt 198 for the first motor 176, and a speed reduction belt 199 for the second motor 178.

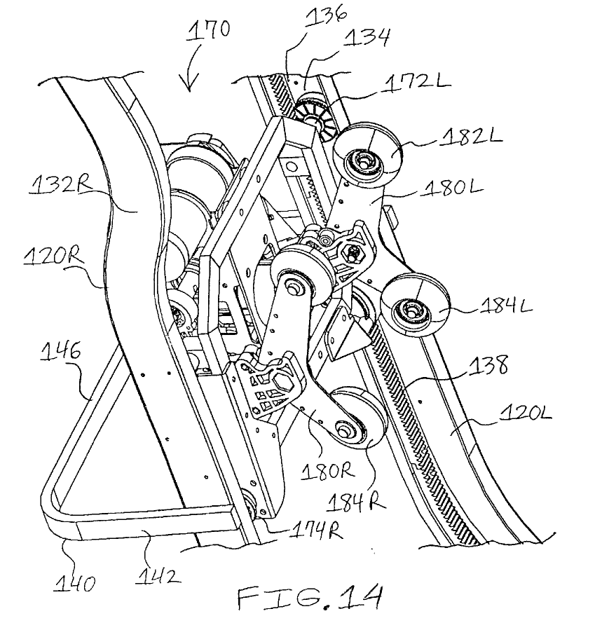

As best shown in FIGS. 13 and 14, each of the pair of massage device moving members 172R,172L is positioned within a corresponding guide channel 136 of a guide rail 120R,120L, and helps the body massage device 170 move in a generally vertical direction along the guide channel 136.

As best shown in FIGS. 13 and 14, each of the pair of gear members 174R,174L is positioned within a corresponding guide channel 136 of a guide rail 120R,120L, and engages with the teeth 138 located in the corresponding guide channel 136.

As best shown in FIGS. 13-17, each of the pair of massage arms 180R,180L includes a first or upper massage roller 182R,182L and a second or lower massage roller 184R,184L. Each of the pair of massage arms 180R,180L can move vertically. As a non-limiting example, each of the pair of massage arms 180R,180L may be able to move both vertically and laterally. The massage rollers 182R,182L,184R,184L provide massage benefits or effects to a back body area, a bottom body area, and a thigh body area of the user when the body massage device 170 is moved to, near or about that particular body area. The massage rollers 182R,182L,184R,184L may also provide massage benefits or effects to a head and neck area of the user when the body massage device 170 is moved to, near or about the head and neck area. It will be understood by one of ordinary skill in the art that the timing of the pattern of the raising and lowering may be varied on each roller 182R,182L,184R,184L, such as by adjusting the degree of rotation of one or more of the following: rotational shaft 192 driven by the first motor 176, pair of rotation to knocking translator members 194, rotational shaft 195 driven by the second motor 178, pair of rotation to kneading translator members 196, speed reduction belt 198 for the first motor 176, and speed reduction belt 199 for the second motor 178. Also, it will be understood by one of ordinary skill in the art that the rate of speed of rotation as well as the direction of rotation of the rollers 182R,182L,184R,184L may be adjusted by varying the motor speed or direction.

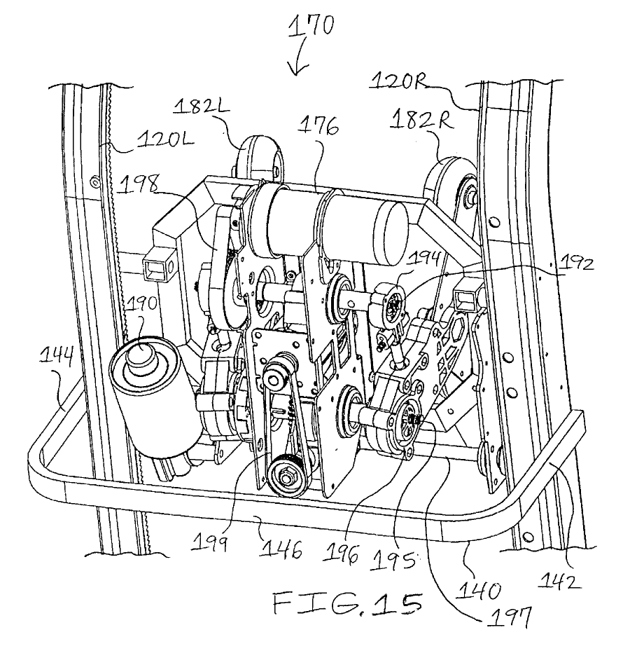

As best shown in FIGS. 15-17, the first and second motors 176,178 provide power to the pair of massage arms 180R,180L, respectively, while the third motor 190 provides power for the generally vertical movement of the body massage device 170.

As best shown in FIGS. 15-17, the rotational shaft 192 driven by the first motor 176 causes the first massage arm 180R to be activated and to carry out its massage actions when this rotational shaft 192 is rotated.

As best shown in FIGS. 15-17, each of the pair of rotation to knocking translator members 194 assists the corresponding massage arm 180R,180L and corresponding massage roller(s) 182R,182L,184R,184L to carry out its knocking massage actions when the corresponding rotational shaft 192,195 is rotated.

As best shown in FIGS. 15-17, the rotational shaft 195 driven by the second motor 178 causes the second massage arm 180L to be activated and to carry out its massage actions when this rotational shaft 195 is rotated.

As best shown in FIGS. 15-17, each of the pair of rotation to kneading translator members 196 assists the corresponding massage arm 180R,180L and corresponding massage roller(s) 182R,182L,184R,184L to carry out its kneading massage actions when the corresponding rotational shaft 192,195 is rotated.

As best shown in FIGS. 15-17, the rotational shaft 197 for vertical movement gears driving causes the body massage device 170 to move upward or downward when this rotational shaft 197 is rotated.

As best shown in FIG. 15, the speed reduction belt 198 for the first motor 176 adjusts the speed of the first massage arm 180R.

As best shown in FIGS. 15-17, the speed reduction belt 199 for the second motor 178 adjusts the speed of the second massage arm 180L.

When in use or in operation, the user (not shown) may activate the body massage device 170 of the body massage apparatus 100 for a massage chair by or via pushing, touching, using voice command for use on or with, using a mechanical or remote control for use on or with, or any other activation method known to one of ordinary skill in the art, an activation, start, control or command button, touch area, box or panel, or any other activation method or element known to one of ordinary skill in the art. Preferably, the user is able to control the generally vertical movement of the body massage device 170 and massage rollers 182R,182L,184R,184L upward and downward along the guide rails 120R,120L such that the body massage device 170 and massage rollers 182R,182L,184R,184L are positioned about, near or at a desired body part area, such as the thighs, bottom, lower back, upper back, and head and neck, of the user so that desired body part area of the user can receive massage effects or benefits from the massage rollers 182R,182L,184R,184L when desired. Preferably, the user is also able to control the timing, movement, etc. of the massage rollers 182R,182L,184R,184L such that that the massage rollers 182R,182L,184R,184L can provide different massage effects or benefits, such as knocking, keading, etc., to the desired body part area of the user at a particular moment or time.

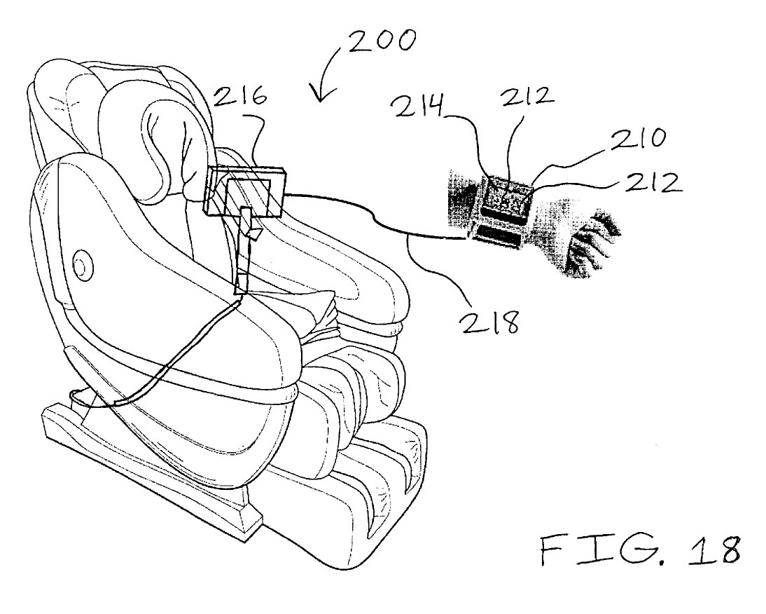

Referring to FIG. 18, the massage chair 200 includes a body massage apparatus and at least one health monitoring device or system 210. The body massage apparatus is preferably body massage apparatus 100, described above, that includes the frame 110 and body massage device 170, or is a body massage apparatus that is substantially similar to body massage apparatus 100.

As a non-limiting example shown in FIG. 18, the at least one health monitoring device or system 210 is a portable, wrist blood pressure and heart rate monitoring device 210 that is manufactured and/or programmed to measure or obtain the blood pressure and heart rate of the user right at or near the massage chair 200 when the user is preferably positioned on the massage chair 200. The blood pressure and heart rate monitoring device 210 is compact, convenient, and does not interfere with the massage functions of the massage chair 200. The blood pressure and heart rate monitoring device 210 provides blood pressure and heart rate measurements, and alerts the user and/or other persons, such as, but not limited to, an individual who is monitoring the user's blood pressure and heart rate. The measurement data 212 that is obtained from the user is displayed either on the device screen 214 or on a remote control 216 of the massage chair 200. The blood pressure and heart rate monitoring device 210 can be quickly connected to or disconnected from the massage chair 200 via a connector or cord 218, such as, but not limited to, a detachable DC power supply cord.

As an alternative to the blood pressure and heart rate monitoring device 210 of this embodiment, the at least one health monitoring device 210 may be a blood pressure monitoring or measuring device and a heart rate monitoring or measuring device that are separate from one another, or just either of those devices. As another alternative to the blood pressure and heart rate monitoring device 210 of this embodiment, the at least one health monitoring device 210 may encompass any individual or combinations of health monitoring functions, such as, but not limited to, blood pressure monitoring and/or measuring, heart rate monitoring or measuring, cholesterol monitoring or measuring, fat monitoring or measuring, and blood sugar monitoring or measuring. Alternatively, the at least one health monitoring device 210 may be or include any health monitoring device(s) that is/are known to one of ordinary skill in the art.

It is to be understood that the present invention is not limited to the embodiments described above or as shown in the attached figures, but encompasses any and all embodiments within the spirit of the invention.

1. A legs and feet massage apparatus for providing massaging effects to the legs and feet of a user, said legs and feet massage apparatus comprising:
a legs and feet frame comprising a pair of guide rails and at least one connecting bar,
wherein each of said guide rails comprises an upper end, a lower end, an upper section located closer to said upper end than said lower end, a lower section located closer to said lower end than said upper end, a connecting section connecting said upper section and said lower section of a corresponding guide rail of said guide rails, an outer side, an inner side, and a guide channel extending from said upper section into said lower section and running along said inner side of said corresponding guide rail of said guide rails,
wherein each of said at least one connecting bar comprises a first end, a second end, and a body portion extending from said first end to said second end, and wherein said first end of said connecting bar is secured to a first guide rail of said guide rails and said second end of said connecting bar is secured to a second guide rail of said guide rails,
wherein each of said upper section of said guide rail correspond to a lower leg area of a user when the user is positioned upon said legs and feet frame, and
wherein each of said lower section of said guide rail correspond to a foot area of the user when the user is positioned upon said legs and feet frame;
a feet massage roller assembly comprising a plurality of feet massage roller devices and a motor,
wherein said plurality of feet massage roller devices are moved along said guide channels of said guide rails by said motor providing power to rotate said plurality of feet massage roller devices whereby said plurality of feet massage roller devices move along said guide channels while also are adapted to provide massaging effects to the soles of the feet and the backsides of the ankles and calves of the user,
wherein said plurality of feet massage roller devices engage with said guide channels when said plurality of feet massage roller devices move upward and downward in a generally vertical direction along said vertical section and said connecting section from said upper end toward said lower end of each of said guide rails and vice versa, respectively, and move forward and rearward in a generally horizontal direction along said lower section of each of said guide rails, and
wherein each of said plurality of feet massage roller devices has a first end with a rotational shaft, a second end for engaging with a corresponding guide channel of said guide channels of said guide rails, and a main massage roller positioned between said first end and said second end, wherein each main massage roller has at least one smaller massage roller positioned upon an outer surface of said main massage roller whereby said smaller massage rollers are adapted to provide massaging effects to the soles of the feet and the backsides of the ankles and calves of the user as said plurality of feet massage roller devices move along said guide channels of said guide rails; and
at least one limit device preventing said feet massage roller assembly from exiting said guide channels at either of said upper ends and said lower ends of said guide rails.

2. The legs and feet massage apparatus according to claim 1, wherein said guide rails are opposing guide rails and are substantially similar to one another.

3. The legs and feet massage apparatus according to claim 1, wherein each of said guide rails has a generally “L-shaped” configuration.

4. The legs and feet massage apparatus according to claim 1, wherein said at least one limit device is at least one limit sensor, and wherein said feet massage roller assembly further comprises software providing communication between said at least one limit sensor and said feet massage roller assembly such that said at least one limit sensor prevents said feet massage roller assembly from exiting said guide channels at either of said upper ends and said lower ends of said guide rails.

5. The legs and feet massage apparatus according to claim 1, wherein said feet massage roller assembly further comprises a worm gear device, wherein said worm gear device is in communication with said motor such that said worm gear device is powered by said motor to rotate corresponding feet massage roller devices via corresponding rotational shafts of said plurality of feet massage roller devices so that said plurality of feet massage roller devices move along said guide channels when driven by said worm gear device.

6. The legs and feet massage apparatus according to claim 1, wherein said at least one connecting bar comprises an upper connecting bar and a lower connecting bar, and wherein said upper connecting bar is secured about said upper ends of said guide rails while said lower connecting bar is secured about said lower ends of said guide rails.

7. The legs and feet massage apparatus according to claim 1, further comprising at least one calf massage device that is adapted to provide punching massaging effects to the calves of the user.

8. The legs and feet massage apparatus according to claim 7, wherein said at least one calf massage device is at least one right calf massage device and at least one left calf massage device, and wherein each of said at least one right calf massage device and said at least one left calf massage device is secured along said upper section of a corresponding guide rail.

9. The legs and feet massage apparatus according to claim 8, wherein said at least one right calf massage device is a right set of calf massage devices and said at least one left calf massage device is a left set of calf massage devices, wherein each of said right set of calf massage devices and of said left set of calf massage devices comprises an upper calf massage device and a lower calf massage device, wherein both of said upper calf massage device and said lower calf massage device of each set are secured along said upper section of a corresponding guide rail wherein said upper calf massage devices face toward one another and said lower calf massage devices face toward one another.

10. A legs and feet massage apparatus for providing massaging effects to the legs and feet of a user, said legs and feet massage apparatus comprising:
a legs and feet frame comprising a pair of guide rails, an upper connecting bar, and a lower connecting bar,
wherein each of said guide rails comprises an upper end, a lower end, an upper section located closer to said upper end than said lower end, a lower section located closer to said lower end than said upper end, a connecting section connecting said upper section and said lower section of a corresponding guide rail of said guide rails, an outer side, an inner side, and a guide channel extending from said upper section into said lower section and running along said inner side of said corresponding guide rail of said guide rails,
wherein each of said upper connecting bar and said lower connecting bar comprises a first end, a second end, and a body portion extending from said first end to said second end, and wherein said upper connecting bar is secured about said upper ends of said guide rails while said lower connecting bar is secured about said lower ends of said guide rails,
wherein each of said upper section of said guide rail correspond to a lower leg area of a user when the user is positioned upon said legs and feet frame, and
wherein each of said lower section of said guide rail correspond to a foot area of the user when the user is positioned upon said legs and feet frame;
a feet massage roller assembly comprising a plurality of feet massage roller devices, a worm gear device, and a motor,
wherein said plurality of feet massage roller devices are moved along said guide channels of said guide rails by said motor powering said worm gear device to rotate said plurality of feet massage roller devices such that said plurality of feet massage roller devices move along said guide channels while also are adapted to provide massaging effects to the soles of the feet and the backsides of the ankles and calves of the user,
wherein each of said feet massage roller devices comprises a first end with a rotational shaft that is connected to said worm gear device or said motor, respectively, a second end with a plurality of driving gears for engaging with corresponding guide channel of said guide rails, and a main massage roller positioned between said first end and said second end, wherein each of said main massage rollers comprises a plurality of smaller massage rollers surrounding an outer surface of said main massage roller, wherein said plurality of smaller massage rollers are adapted to provide massaging effects to the soles of the feet and backsides of the ankles and calves of the user as said feet massage roller devices move along said guide channels of said guide rails,
wherein said worm gear device is in communication with said motor such that said worm gear device is powered by said motor to rotate corresponding feet massage roller devices of said plurality of feet massage roller devices via corresponding rotational shafts of said rotational shafts so that said corresponding feet massage roller devices move along said guide channels when driven by said worm gear device, and
wherein said motor powers said worm gear device to rotate said corresponding feet massage roller devices of said plurality of feet massage roller devices via said corresponding rotational shafts of said rotational shafts while itself rotating corresponding feet massage roller devices of said feet massage roller devices via corresponding rotational shafts of said rotational shafts such that said plurality of feet massage roller devices move along said guide channels of said guide rails when driven by said worm gear device, and
wherein a plurality of driving gears of said plurality of feet massage roller devices engage with a plurality of gear teeth of said guide channels when said plurality of feet massage roller devices move upward and downward in a generally vertical direction along said upper section and said connecting section from said upper end toward said lower end of each of said guide rails and vice versa, respectively, and moves forward and rearward in a generally horizontal direction along said lower section of each of said guide rails;
at least one calf massage device adapted to provide punching massaging effects to the calves of the user; and
at least one limit device preventing said feet massage roller assembly from exiting said guide channels at either of said upper ends and said lower ends of said guide rails.

11. The legs and feet massage apparatus according to claim 10, wherein said at least one calf massage device is at least one right calf massage device and at least one left calf massage device, and wherein each of said at least one right calf massage device and said at least one left calf massage device is secured along said upper section of a corresponding guide rail.

12. The legs and feet massage apparatus according to claim 11, wherein said at least one right calf massage device is a right set of calf massage devices and said at least one left calf massage device is a left set of calf massage devices, wherein each of said right set of calf massage devices and of said left set of calf massage devices comprises an upper calf massage device and a lower calf massage device, wherein both of said upper calf massage device and said lower calf massage device of each set are secured along said upper section of a corresponding guide rail wherein said upper calf massage devices face toward one another and said lower calf massage devices face toward one another.

13. The legs and feet massage apparatus according to claim 10, wherein said guide rails are opposing guide rails and are substantially similar to one another.

14. The legs and feet massage apparatus according to claim 10, wherein each of said guide rails has a generally “L-shaped” configuration.

15. The legs and feet massage apparatus according to claim 10, wherein said at least one limit device is at least one limit sensor, and wherein said feet massage roller assembly further comprises software providing communication between said at least one limit sensor and said feet massage roller assembly such that said at least one limit sensor prevents said feet massage roller assembly from exiting said guide channels at either of said upper ends and said lower ends of said guide rails.

16. A massage chair comprising:
a body massage apparatus comprising a body frame and a body massage device,
wherein said body frame comprises at least one body frame guide rail, wherein each of said at least one body frame guide rail comprises a first end, a second end, a thigh body area portion located about said first end, a bottom body area portion located proximate said thigh body area portion and away from said first end, and a back body area portion extending upward from said bottom body area portion,
wherein said body massage device comprises a power source and at least one massage element,
wherein said body massage device is secured to said at least one body frame guide rail, and
wherein said power source provides power to said body massage device wherein said at least one massage element is moved with respect to said at least one body frame guide rail whereby said at least one massage element is adapted to provide massage effects to a thigh body area, a bottom body area, and a back body area of a user; and
a legs and feet massage apparatus for providing massaging effects to the legs and feet of a user,
wherein said legs and feet massage apparatus is secured about an area of said massage chair where the legs of the user are positioned when the user is positioned upon said massage chair,
wherein said legs and feet massage apparatus comprises:
a legs and feet frame comprising a pair of guide rails and at least one connecting bar,
wherein each of said guide rails comprises an upper end, a lower end, an upper section located closer to said upper end than said lower end, a lower section located closer to said lower end than said upper end, a connecting section connecting said upper section and said lower section of a corresponding guide rail of said guide rails, an outer side, an inner side, and a guide channel extending from said upper section into said lower section and running along said inner side of said corresponding guide rail of said guide rails, and
wherein each of said at least one connecting bar comprises a first end, a second end, and a body portion extending from said first end to said second end, and wherein said first end of said connecting bar is secured to a first guide rail of said guide rails and said second end of said connecting bar is secured to a second guide rail of said guide rails,
a feet massage roller assembly comprising a plurality of feet massage roller devices and a motor,
wherein said plurality of feet massage roller devices are moved along said guide channels of said guide rails by said motor providing power to rotate said plurality of feet massage roller devices whereby said plurality of feet massage roller devices move along said guide channels while also are adapted to provide massaging effects to the soles of the feet and the backsides of the ankles and calves of the user,
wherein said plurality of feet massage roller devices engage with said guide channels when said plurality of feet massage roller devices move upward and downward in a generally vertical direction along said upper section and said connecting section from said upper end toward said lower end of each of said guide rails and vice versa, respectively, and move forward and rearward in a generally horizontal direction along said lower section of each of said guide rails, and
wherein each of said plurality of feet massage roller devices has a first end with a rotational shaft, a second end for engaging with a corresponding guide channel of said guide channels of said guide rails, and a main massage roller positioned between said first end and said second end, wherein each main massage roller has at least one smaller massage roller positioned upon an outer surface of said main massage roller whereby said smaller massage rollers are adapted to provide massaging effects to the soles of the feet and the backsides of the ankles and calves of the user as said plurality of feet massage roller devices move along said guide channels of said guide rails, and
at least one limit device preventing said feet massage roller assembly from exiting said guide channels at either of said upper ends and said lower ends of said guide rails.

17. The massage chair according to claim 16, wherein said guide rails are opposing guide rails and are substantially similar to one another.

18. The massage chair according to claim 16, wherein each of said guide rails has a generally “L-shaped” configuration.

19. The massage chair according to claim 16, wherein said at least one limit device is at least one limit sensor, and wherein said feet massage roller assembly further comprises software providing communication between said at least one limit sensor and said feet massage roller assembly such that said at least one limit sensor prevents said feet massage roller assembly from exiting said guide channels at either of said upper ends and said lower ends of said guide rails.

20. The massage chair according to claim 16, wherein said feet massage roller assembly further comprises a worm gear device, wherein said worm gear device is in communication with said motor such that said worm gear device is powered by said motor to rotate corresponding feet massage roller devices via corresponding rotational shafts of said plurality of feet massage roller devices so that said plurality of feet massage roller devices move along said guide channels when driven by said worm gear device.

21. The massage chair according to claim 16, wherein said at least one connecting bar comprises an upper connecting bar and a lower connecting bar, and wherein said upper connecting bar is secured about said upper ends of said guide rails while said lower connecting bar is secured about said lower ends of said guide rails.

22. The massage chair according to claim 16, further comprising at least one calf massage device for providing punching massaging effects to the calves of the user.

23. The massage chair according to claim 22, wherein said at least one calf massage device is at least one right calf massage device and at least one left calf massage device, and wherein each of said at least one right calf massage device and said at least one left calf massage device is secured along said upper section of a corresponding guide rail.

24. The massage chair according to claim 23, wherein said at least one right calf massage device is a right set of calf massage devices and said at least one left calf massage device is a left set of calf massage devices, wherein each of said right set of calf massage devices and of said left set of calf massage devices comprises an upper calf massage device and a lower calf massage device, wherein both of said upper calf massage device and said lower calf massage device of each set are secured along said upper section of a corresponding guide rail wherein said upper calf massage devices face toward one another and said lower calf massage devices face toward one another.
